(19) United States
(12) Patent Application Publication
(10) Pub. No.: US 2009/0033985 A1
(43) Pub. Date: Feb. 5, 2009

(54) MOBILE DEVICE, PRINTER SERVER AND PRIVATE NETWORK SYSTEM, AND METHODS TO RECEIVE FAX DATA THEREBY

(75) Inventor: Mikhail PLATOV, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/172,289

(22) Filed: Jul. 14, 2008

(30) Foreign Application Priority Data
Jul. 30, 2007 (KR) 2007-76558

(51) Int. Cl. G06F 3/12

(52) U.S. Cl. 358/1.15

(57) ABSTRACT

A private network system includes a PBX to transmit a message to inquire about receipt of fax data to a mobile device if a message notifying that the fax data will be transmitted is received via an external repeater, a receiver to receive the fax data transmitted from an external device if a fax receipt command is input from the mobile device, and a printer server to check information regarding a printer adjacent to the mobile device from among a plurality of printers, and to control the receiver to transmit the fax data to the checked printer. Accordingly, the private network system facilitates providing the fax data to a printer which is, for example, most suitable for receipt of the fax data, using information regarding the position of a fax recipient and printer information, and thus user convenience can be increased.

### CROSS-REFERENCE TO RELATED APPLICATIONS

This application claims priority under 35 U.S.C. §119(a) from Korean Patent Application No. 10-2007-0076558, filed on Jul. 30, 2007, in the Korean Intellectual Property Office, the disclosure of which is incorporated herein by reference in its entirety.

### BACKGROUND OF THE INVENTION

1. Field of the Invention

The present general inventive concept relates to a mobile device, a printer server and a private network system including the mobile device and printer server, and methods to receive fax data thereby. More particularly, the present general inventive concept relates to a mobile device, a printer server and a private network system including the mobile device and printer server, and methods to receive fax data thereby, in which a user of the mobile device can determine whether to receive fax data and a printer adjacent to the mobile device may receive the fax data.

2. Description of the Related Art

In order to set up networks, considerable initial costs are required to install various types of communication network equipment and software, in addition to high costs of communication lines. Additionally, human resources and material resources are needed to operate and manage communication networks. Accordingly, private networks are constructed using public networks, such as the Internet, as leased lines over local area networks (LAN) in offices and homes.

Therefore, devices such as printers, facsimile machines, scanners and host devices may be connected and used in private networks.

Facsimile machines convert letters, diagrams and photographs into electrical signals, and transmit the converted electrical signals to remote locations. Recipients then reproduce original images using the electrical signals, so that a duplicate image can be obtained.

If a document is transmitted using a facsimile machine, a user may check a confirmation tone or a message generated when transmission is completed at a sender's facsimile machine, so knowing that the document has been completely transmitted is possible. However, if the recipient of the fax does not recognize that fax data has been transmitted, he or she is unable to receive the fax data.

If a plurality of fax receivers are connected to a network, the fax recipient needs to check each receiver, and to check fax documents, which reduces user convenience.

Additionally, as fax documents are transmitted regardless of whether a fax recipient is able to receive fax documents, the fax recipient being able to choose whether to receive the fax documents is impossible. Accordingly, fax documents are output even when the fax recipient can not receive the fax documents.

### SUMMARY OF THE INVENTION

The present general inventive concept provides a mobile device and a method to receive fax data thereof to enable a user to receive via the mobile device the fax data and information regarding a printer which has printed the fax data so that easily checking the fax data and information is possible.

The present general inventive concept also provides a printer server to provide fax data through a printer which is, for example, the most suitable to receive the fax data using information regarding a respective position of mobile devices and information regarding printers.

The present general inventive concept further provides a private network system and a method to output fax data to a printer adjacent to a mobile device using the mobile device and a printer server.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a mobile device including an interface unit to receive an inquiry message inquiring about receipt of fax data from a repeater, an input unit to receive a fax receipt command, a controller to request transmission of the fax data to the repeater in response to the inquiry message and the fax receipt command so that the fax data may be printed via a printer adjacent to the mobile device, and an output unit to output information regarding a printer that has printed the fax data, if the information is received via the repeater and interface unit.

The foregoing and/or other aspects and utilities of the present general inventive concept may also be achieved by providing a printer server connected to an external device to receive fax data, the printer server including an interface unit to receive from an external repeater a fax recipient's number corresponding to the fax data received from the external device, a position detecting unit to detect information regarding a position of a mobile device corresponding to the fax recipient's number, a storage unit to store information regarding a plurality of printers, and a controller to check the information regarding a respective printer corresponding to the detected information, and to cause the fax data to be transmitted to the checked printer, so that the printer may print the fax data.

The controller may transmit a list of printers to the mobile device, and may cause the fax data to be transmitted to the printer selected from the list.

If the printer completes printing the fax data, the controller may transmit a message notifying the mobile device that printing has been completed through the interface unit and repeater.

The information regarding the printer may include information regarding at least one of a position of the printer, whether access is allowed or denied by a fax recipient, a consumption state, a printer work load and user preferences.

The foregoing and/or other aspects and utilities of the present general inventive concept may also be achieved by providing a private network system including a private branch exchange (PBX) to transmit a message to inquire about receipt of fax data to a mobile device if a message notifying that the fax data will be transmitted is received via an external repeater, a receiver to receive the fax data transmitted from an external device if a fax receipt command is input from the mobile device, and a printer server to check information regarding a printer adjacent to the mobile device from among a plurality of printers, and to control the receiver to transmit the fax data to the checked printer.

The foregoing and/or other aspects and utilities of the present general inventive concept may also be achieved by providing a method of receiving fax data in a mobile device, the method including receiving an inquiry message inquiring about receipt of the fax data from a repeater, proving a user interface (UI) to receive a fax receipt command, requesting transmission of the fax data to the repeater in response to the fax receipt command so that the fax data may be printed via a printer adjacent to the mobile device, and outputting information regarding the printer if the fax data has been completely printed on the printer.

The foregoing and/or other aspects and utilities of the present general inventive concept may also be achieved by providing a method of receiving fax data in a private network system, the method including transmitting, by a private branch exchange (PBX), a message to inquire about receipt of the fax data to a mobile device if a message notifying that the fax data will be transmitted is received via an external repeater, receiving, by a receiver including a fax function, the fax data transmitted from an external device if a fax receipt command is input from the mobile device, checking information regarding a printer adjacent to the mobile device from among a plurality of printers, by a printer server, and controlling the receiver to transmit the fax data to the checked printer, by the printer server, and printing the fax data received from the receiver via the printer.

The method may further include notifying, by the printer server, the mobile device of completion of printing and of the information regarding the printer, if the fax data has been completely printed.

The checking may include receiving a fax recipient's number corresponding to the fax data received from the receiver, detecting information regarding a position of a mobile device corresponding to the fax recipient's number, checking the information regarding the printer corresponding to the detected information from stored information regarding the printer, and selecting a printer to print the fax data, and transmitting the fax data to the selected printer.

The checking may include transmitting a list of the corresponding printers to the mobile device, and if one printer is selected from the list on the mobile device, transmitting the fax data to the selected printer.

The information regarding the printer may include information regarding at least one of a position of the printer, whether access is allowed or denied by a fax recipient, a consumption state, a printer work load and user preferences.

The foregoing and/or other aspects and utilities of the general inventive concept may also be achieved by providing a mobile faxing system usable with a plurality of printers of a private network, the mobile faxing system including a mobile device to determine whether to receive fax data, and a printer server to receive and provide the fax data to a respective one or more of the plurality of printers based on one or more of the determination of the mobile device, a position of the mobile device and a position of the respective one or more printers.

The foregoing and/or other aspects and utilities of the general inventive concept may also be achieved by providing a faxing method of a mobile faxing system, the faxing method including determining whether to receive fax data by a mobile device, and receiving and providing the fax data by a printer server to a respective one or more printers based on one or more of the determination of the mobile device, a position of the mobile device and a position of the respective one or more printers.

The foregoing and/or other aspects and utilities of the general inventive concept may also be achieved by providing a computer-readable recording medium having embodied thereon a computer program to execute a method, wherein the method including determining whether to receive fax data by a mobile device, and receiving and providing the fax data by a printer server to a respective one or more printers based on one or more of the determination of the mobile device, a position of the mobile device and a position of the respective one or more printers.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a fax data receipt process in a private network environment according to an exemplary embodiment of the present general inventive concept;

FIG. 2 is a block diagram illustrating a mobile device according to an exemplary embodiment of the present general inventive concept;

FIG. 3 is a block diagram illustrating a private network system according to an exemplary embodiment of the present general inventive concept;

FIG. 4 is a block diagram illustrating a printer server according to an exemplary embodiment of the present general inventive concept;

FIG. 5 is a flowchart illustrating a method to receive fax data in a mobile device according to an exemplary embodiment of the present general inventive concept; and

FIG. 6 is a flowchart illustrating a method to receive fax data in a private network system according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

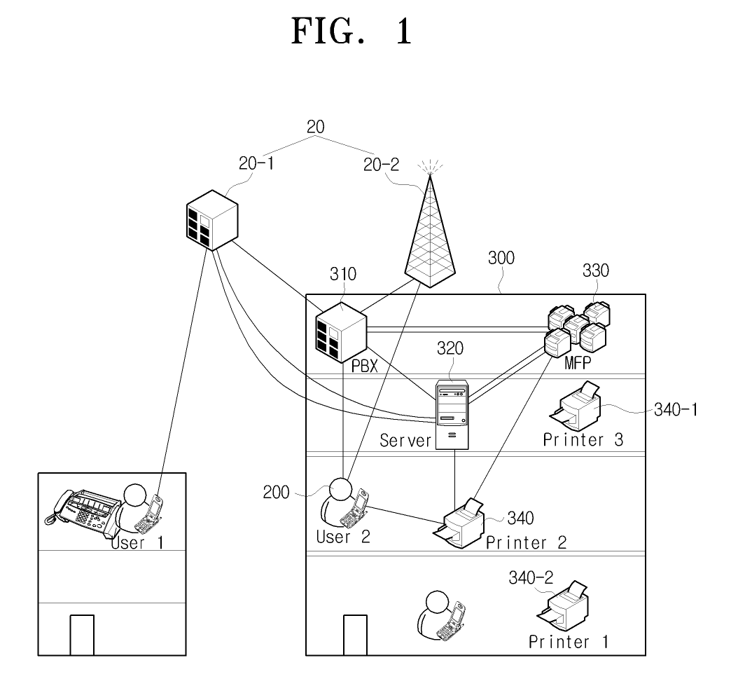

FIG. 1 is a view illustrating a fax data receipt process in a private network environment according to an exemplary embodiment of the present general inventive concept. The network environment of FIG. 1 is used when a fax sender User 1 outside the private network desires to transmit fax data to a fax recipient User 2 using the private network.

In FIG. 1, the fax sender User 1 may transmit a fax receipt inquiry message together with the fax data to a number of a mobile device 200 or a Private Branch eXchange (PBX) number of the fax recipient User 2.

A first external repeater 20-1 may receive the fax data and number of the fax recipient User 2. In this situation, if the number of the fax recipient User 2 is the number of the mobile device 200, the first external repeater 20-1 may call the mobile device 200 of the fax recipient User 2 through a second external repeater 20-2, and if the number of the fax recipient User 2 is the PBX number, the first external repeater 20-1 may call the mobile device 200 of the fax recipient User 2 through a PBX 310.

If the fax recipient User 2 inputs a fax receipt command, a series of key values may be transmitted to the first external repeater 20-1 in response to the fax receipt inquiry message.

If the series of key values are received, the first external repeater 20-1 may transmit the fax data that has been received by the fax sender User 1 to a receiver, namely, a multifunction peripheral (MFP) 330. The MFP 330 may request a printer's Internet protocol (IP) address from a server in order to print the fax data.

The server may detect information regarding a position of the fax recipient User 2 using a Global Positioning System (GPS) of the mobile device 200 of the fax recipient User 2.

The server may then search for a printer which is, for example, the most favorable to print the fax data, using the detected information regarding a position of the fax recipient User 2 and prestored printer information, and may transmit an IP address for the searched printer to the MFP 330.

The MFP 330 may transmit the stored fax data to the printer corresponding to the received IP address. If the fax data can not be transmitted to the printer of the corresponding IP address, the MFP 330 may send a request to the server for the IP address of another printer, again.

A printer 340 may receive the fax data from the MFP 330, print the received data, and inform the printer server 320 that printing has been completed.

The printer server 320 may transmit information regarding the printer that has printed the fax data to the mobile device 200 of the fax recipient User 2 using a short message service (SMS).

Accordingly, the fax recipient User 2 may check the transmitted information and receive the fax data transmitted from the fax sender User 1.

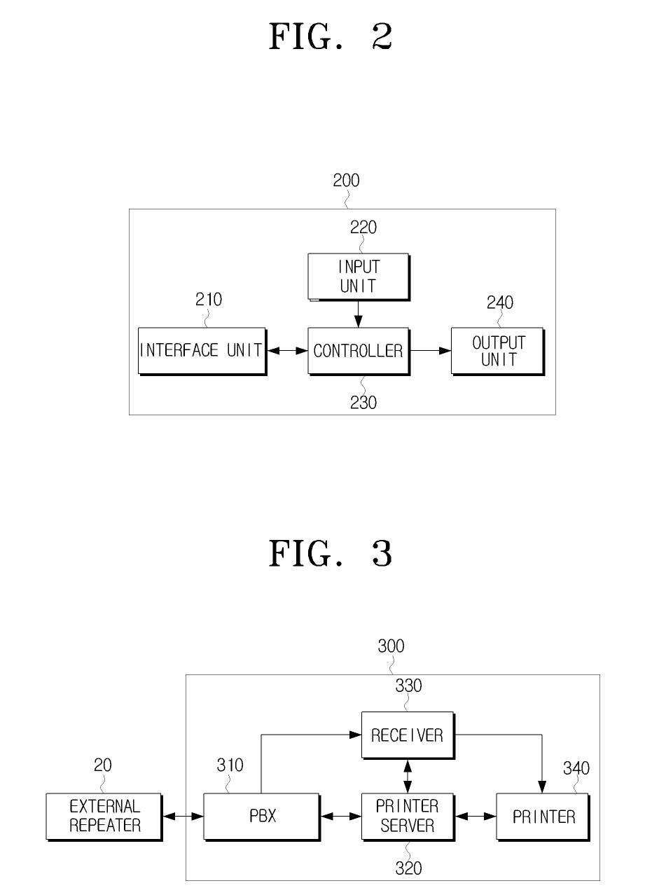

Hereinafter, the above process will be described in detail with reference to FIGS. 2 to 4 in order to facilitate understanding of the present general inventive concept.

In this situation, the fax recipient User 2 may determine whether to receive the fax data using the mobile device 200. The configuration of the mobile device 200 is illustrated in FIG. 2.

FIG. 2 is a block diagram illustrating the mobile device 200 according to the exemplary embodiment of the present general inventive concept. The mobile device 200 of FIG. 2 includes an interface unit 210, an input unit 220, a controller 230 and an output unit 240.

The interface unit 210 may receive an inquiry message inquiring about receipt of fax data. The inquiry message may be received from the fax sender User 1 through the first repeater 20-1 and second repeater 20-2, or through the first repeater 20-1 and PBX 310.

The first repeater 20-1 may be a public switched telephone network (PSTN), and the second repeater 20-2 may be a mobile phone base station. The first repeater 20-1 needs to include an interface and a protocol in order to connect a wired terminal to a mobile terminal.

The first repeater 20-1 may transmit the fax data using one protocol selected from among a Socket Application Programming Interface (API), AppSocket, an Internet Printing Protocol (IPP) (RFC2566), a Server Message Block (SMB) and a Line Printer Daemon protocol (LPD) (RFC1179).

The inquiry message may be received in various forms, for example a voice message or a text message.

The input unit 220 may receive the fax receipt command in response to the received inquiry message. In this situation, a user may enter the fax receipt command using buttons included in a panel of the mobile device 200, or a user interface (UI) provided by a display unit (not illustrated) of the mobile device 200, or by his voice.

If the fax receipt command is input in response to the inquiry message, the controller 230 may transmit a serial of key sequence values requesting that the fax data be transmitted to the repeater 20 so that the fax data may be printed via the most suitable printer from among printers 340, 340-1 and 340-2 (FIG. 1) adjacent to the mobile device 200.

If information regarding the printer 340 that has printed the fax data is received via an external repeater 20 and the interface unit 210, the output unit 240 may output the received information.

In this situation, the received information may include the fax receipt time, fax recipient's name, fax sender's name, and name and position information regarding the printer on which the fax data is printed.

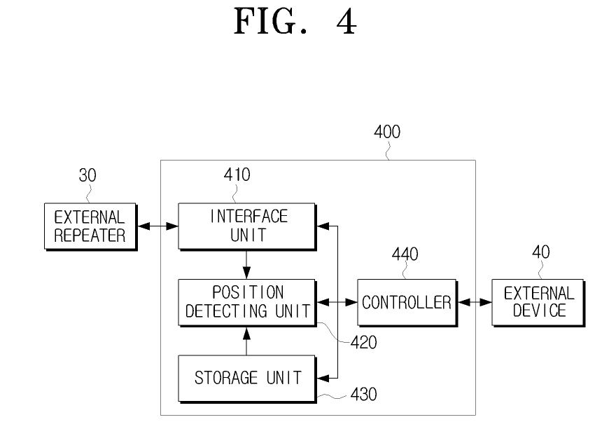

FIG. 3 is a block diagram illustrating a private network system 300 according to the exemplary embodiment of the present general inventive concept. The private network system 300 of FIG. 3 includes the PBX 310, the printer server 320, the receiver 330 and the plurality of printers 340, 340-1 and 340-2. The PBX 310 may be connected to the external repeater 20.

Referring to FIGS. 1 and 3, if a message notifying that the fax data will be transmitted is received via the external repeater 20, the PBX 310 may transmit a message to inquire about receipt of the fax data.

If a fax receipt command is received from the mobile device 200, the receiver 330 may receive the fax data transmitted from an external device. The receiver 330 may be an MFP including a fax function, a facsimile machine or other devices.

The printer server 320 may check information regarding the printers 340, 340-1 and 340-2 adjacent to the mobile device 200, and may control the receiver 330 to transmit the fax data to the most suitable printer. The configuration of the printer server 320 will be described in detail with reference to FIG. 4.

FIG. 4 is a block diagram illustrating a configuration of a printer server of FIG. 3. A printer server 400 of FIG. 4 includes an interface unit 410, the position detecting unit 420, a storage unit 430 and a controller 440. The printer server 400 may receive fax data and a fax recipient's number from an external repeater 30, and may provide an external device 40 with a printer's IP address in order to print the fax data.

The printer server 400 may be applied to the network system 300 of FIG. 3, and accordingly the printer server 400 may perform the same functions as the printer server 320 of FIG. 3. The external repeater 30 may be the PBX 310 of FIG. 3, or the external repeater 20 of FIG. 1, and the external device 40 may be the receiver 330 of FIG. 3.

The interface unit 410 may receive from the external repeater 30 the number of the fax recipient receiving the fax data in the external device 40.

The position detecting unit 420 may detect information regarding the position of the mobile device 200 corresponding to the fax recipient's number. The position of the mobile device 200 may be detected using the GPS. Additionally, the position of the printer and the distance between the mobile device 200 and the printer may be detected using a map table, which is used to store the position of a printer in a private network.

The storage unit 430 may store information regarding the plurality of printers 340, 340-1 and 340-2 in the private network 300.

The information regarding the printers 340, 340-1 and 340-2 may be at least one of the map table to store information regarding positions of the plurality of printers 340, 340-1 and 340-2 in the private network 300, and information regarding whether access is allowed or denied by a fax recipient, a consumption state, printer work load and user preferences.

The controller 440 may check information regarding a printer corresponding to the position of the mobile device, and may control the external device 40 to transmit the fax data to the printer, so that, for example, the most suitable printer can print the fax data.

The controller 440 may transmit a list of printers with high priorities to the mobile device 200, so that the fax recipient can select a printer from the transmitted list of printers.

If a printer is selected via the mobile device 200, the controller 440 may provide an IP address for the selected printer to the external device 40.

If the selected printer completes printing the fax data, the controller 440 may transmit a message to notify the mobile device 200 that printing has been completed via the interface unit 410 and repeater 30. Accordingly, the fax recipient can receive the fax data through an SMS message received by the mobile device 200.

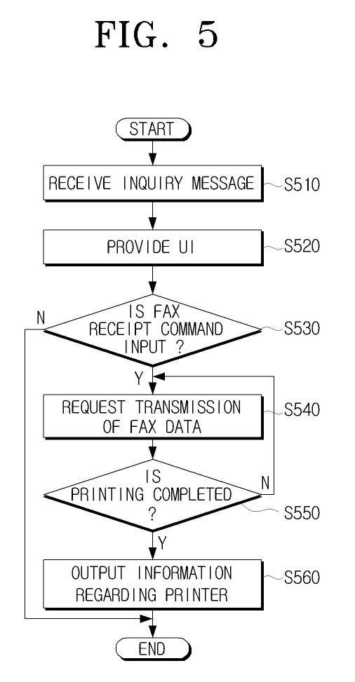

FIG. 5 is a flowchart illustrating a method to receive fax data in a mobile device according to the exemplary embodiment of the present general inventive concept. In FIG. 5, the inquiry message inquiring about receipt of fax data may be received from the external repeater 20 in operation S510. The UI may be provided in order to receive the fax receipt command in response to the inquiry message in operation S520.

The inquiry message may be received in a form of a voice message or a text message. In this situation, the fax receipt command may be received using the buttons included in a panel of the mobile device 200 or by the user's voice.

If the fax receipt command is received in operation S530, the controller 230 may request that the external repeater 20 transmit the fax data, for example, to a printer adjacent to the mobile device 200 in operation S540.

If the fax data has been completely printed via the printer in operation S550, the information regarding the printer may be output, and may be provided to a user in operation S560. The provided information may include the fax receipt time, fax recipient's name, fax sender's name, and name and position information regarding the printer on which the fax data is printed.

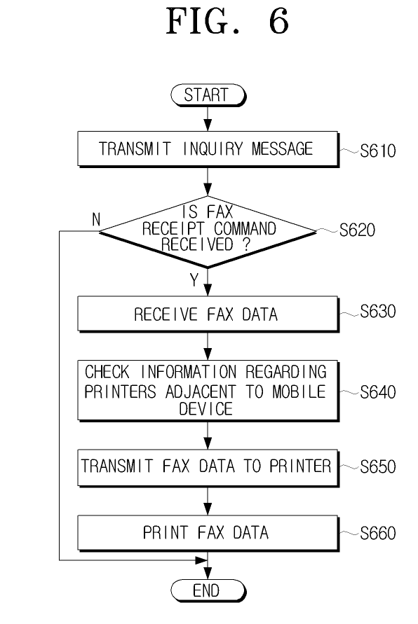

FIG. 6 is a flowchart illustrating a method to receive fax data in a private network system according to the exemplary embodiment of the present general inventive concept. Referring to FIGS. 1 and 6, the message notifying that the fax data will be transmitted is received via the external repeater 20, the PBX 310 may transmit a message to inquire about receipt of the fax data to the mobile device 200 in operation S610.

If the fax receipt command is received from the mobile device 200 in operation S620, the receiver 330 including the fax function may receive the fax data transmitted from an external device in operation S630.

The printer server 320 may then check information regarding the printers 340, 340-1 and 340-2 adjacent to the mobile device 200 in operation S640.

The information regarding the printers may be at least one of the map table to store information regarding positions of the plurality of printers 340, 340-1 and 340-2 in the private network 300, and information regarding whether access is allowed or denied by a fax recipient, the consumption state, the printer work load and user preferences.

Specifically, information regarding the position of the mobile device 200 corresponding to the fax recipient's number may be detected. The position of the mobile device 200 may be detected using the GPS. Additionally, the position of a printer and the distance between the mobile device 200 and the printer may be detected using a map table. Furthermore, comparison in information regarding printers is performed so that information on, for example, the most suitable printer can be obtained.

As a result of the comparison, a list of printers having high priorities may be transmitted to the mobile device, so that the user can select a desired printer.

Accordingly, IP addresses for the printer selected by the user or for the most suitable printer may be transmitted to the receiver 330.

The receiver 330 may transmit the fax data to the printer 340 at the corresponding IP address in operation S650, and the printer 340 may then print the fax data.

If the fax data is completely printed, the printer server 320 may notify the mobile device 200 of completion of printing and of the information regarding the printer, so that the fax recipient can check notifications. The information provided to the fax recipient may include the fax receipt time, fax recipient's name, fax sender's name, and name and position information regarding the printer on which the fax data is printed. Accordingly, the fax data may be provided according to the position of the fax recipient in the private network, and user convenience may thus be increased. Additionally, the inquiry message may be transmitted, and thus the fax recipient can determine whether to receive the fax data.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

According to various embodiments of the present general inventive concept, a mobile device receives an inquiry message and information of a printer that has printed fax data, and provides the information to a user, and accordingly the user can determine whether to receive the fax data.

In addition, the printer server according to various embodiments of the present general inventive concept may provide a mobile device with a list of printers to be selected using information regarding a position of the mobile device and the printer information so that a respective printer can be selected to receive fax data. Furthermore, the fax data may be output, for example, to one or more printers adjacent to a fax recipient using the mobile device and printer server. Therefore, user convenience can be enhanced.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A mobile device, comprising:
an interface unit to receive an inquiry message inquiring about receipt of fax data from a repeater;
an input unit to receive a fax receipt command;
a controller to request transmission of the fax data to the repeater in response to the inquiry message and the fax receipt command so that the fax data is printed via a printer adjacent to the mobile device; and
an output unit to output information regarding a printer that has printed the fax data, if the information is received via the repeater and interface unit.

2. A printer server connected to an external device to receive fax data, the printer server comprising:
an interface unit to receive from an external repeater a fax recipient's number corresponding to the fax data received from the external device;
a position detecting unit to detect information regarding a position of a mobile device corresponding to the fax recipient's number;
a storage unit to store information regarding a plurality of printers; and
a controller to check the information regarding a respective printer corresponding to the detected information, and to cause the fax data to be transmitted to the checked printer, so that the printer prints the fax data.

3. The printer server of claim 2, wherein the controller transmits a list of printers to the mobile device, and causes the fax data to be transmitted to a respective printer selected from the list.

4. The printer server of claim 3, wherein, if the printer completes printing the fax data, the controller transmits a message notifying the mobile device that printing has been completed through the interface unit and repeater.

5. The printer server of claim 2, wherein the information regarding the printer comprises:
information regarding at least one of a position of the printer, whether access is allowed or denied by a fax recipient, a consumption state, a printer work load and user preferences.

6. A private network system, comprising:
a private branch exchange (PBX) to transmit a message to inquire about receipt of fax data to a mobile device if a message notifying that the fax data will be transmitted is received via an external repeater;
a receiver to receive the fax data transmitted from an external device if a fax receipt command is input from the mobile device; and
a printer server to check information regarding a printer adjacent to the mobile device from among a plurality of printers, and to control the receiver to transmit the fax data to the checked printer.

7. A method of receiving fax data in a mobile device, the method comprising:
receiving an inquiry message inquiring about receipt of the fax data from a repeater;
proving a user interface (UI) to receive a fax receipt command;
requesting transmission of the fax data to the repeater in response to the fax receipt command so that the fax data is printed via a printer adjacent to the mobile device; and
outputting information regarding the printer if the fax data has been completely printed on the printer.

8. A method of receiving fax data in a private network system, the method comprising:
transmitting, by a private branch exchange (PBX), a message to inquire about receipt of the fax data to a mobile device if a message notifying that the fax data will be transmitted is received via an external repeater;
receiving, by a receiver including a fax function, the fax data transmitted from an external device if a fax receipt command is input from the mobile device;
checking information regarding a printer adjacent to the mobile device from among a plurality of printers, by a printer server, and controlling the receiver to transmit the fax data to the checked printer, by the printer server; and
printing the fax data received from the receiver via the printer.

9. The method of claim 8, further comprising:
notifying, by the printer server, the mobile device of completion of printing and of the information regarding the printer, if the fax data has been completely printed.

10. The method of claim 8, wherein the checking comprises:
receiving a fax recipient's number corresponding to the fax data received from the receiver;
detecting information regarding a position of a mobile device corresponding to the fax recipient's number;
checking the information regarding the printer corresponding to the detected information from stored information regarding the printer, and selecting a printer to print the fax data; and
transmitting the fax data to the selected printer.

11. The method of claim 8, wherein the checking comprises:
transmitting a list of the corresponding printers to the mobile device; and
if one printer is selected from the list on the mobile device, transmitting the fax data to the selected printer.

12. The method of claim 8, wherein the information regarding the printer comprises:
information regarding at least one of a position of the printer, whether access is allowed or denied by a fax recipient, a consumption state, a printer work load and user preferences.

13. A mobile faxing system usable with a plurality of printers of a private network, the mobile faxing system comprising:
a mobile device to determine whether to receive fax data; and
a printer server to receive and provide the fax data to a respective one or more of the plurality of printers based on one or more of the determination of the mobile device, a position of the mobile device and a position of the respective one or more printers.

14. A faxing method of a mobile faxing system, the faxing method comprising:
determining whether to receive fax data by a mobile device; and
receiving and providing the fax data by a printer server to a respective one or more printers based on one or more of the determination of the mobile device, a position of the mobile device and a position of the respective one or more printers.

15. A computer-readable recording medium having embodied thereon a computer program to execute a method, wherein the method comprises:
determining whether to receive fax data by a mobile device; and
receiving and providing the fax data by a printer server to a respective one or more printers based on one or more of the determination of the mobile device, a position of the mobile device and a position of the respective one or more printers.
